(19) United States
(12) Patent Application Publication
(10) Pub. No.: US 2010/0040434 A1
(43) Pub. Date: Feb. 18, 2010

(54) FASTENER

(75) Inventors: RI-LANG YANG, Shenzhen City (CN); GUANG YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/264,265

(22) Filed: Nov. 4, 2008

(30) Foreign Application Priority Data
Aug. 13, 2008 (CN) 200810303721.4

(51) Int. Cl. F16B 21/00

(52) U.S. Cl. 411/447

(57) ABSTRACT

A fastener for connecting two components together comprises a bolt having a head and a shaft extending integrally and downwardly from the head, an elastic member coiled around the shaft and a shell receiving the elastic member and the bolt therein and keeping the elastic member coiled around the shaft. The shell encloses the bolt and the elastic member therein to form the fastener as a single unit. The shell has a top wall against which the head of the bolt abuts and a bottom wall through which a lower portion of the shaft extends. The top wall defines a through hole to expose the head of the bolt. The elastic member is compressed between the bottom wall and the head.

### BACKGROUND

1. Field of the Invention

The present invention generally relates to a fastener, and more particularly to a fastener with an elastic member always kept on a shaft of a bolt.

2. Description of Related Art

It is well known that a fastener is used for connecting two or more components together.

Referring to FIG. 3, a conventional fastener includes a bolt having a head 10 and a shaft 20 extending integrally and downwardly from the head 10 and a spring 30 coiled around the shaft 20 of the bolt. The head 10 defines a cross-shaped groove 12 in a top end thereof for facilitating operation of a tool such as a screwdriver thereon. During use of the fastener, the shaft 20 extends through a through hole 52 defined in a first component 50 and aligning with a threaded hole 62 defined in a second component 60, and then a tip of the screwdriver is brought to fit into the cross-shaped groove 12 and exert a downwardly pushing and rotating force on the head 10, thereby pushing downwardly and turning the fastener at the same time, so that the shaft 20 of the fastener is threadedly engaged into the threaded hole 62 of the second component 60. The spring 30 is sandwiched between the head 10 and the first component 50, whereby the first component 50 and the second component 60 is securely connected together.

However, the spring 30 and the shaft 20 are always separated as two independent components before the fastener is used. When the fastener is needed to fasten the two components 50, 60 together, the spring 30 and the shaft 20 are brought together, and the spring 30 is put onto the shaft 20 to coil therearound, before the shaft 20 is extended through the first component 50 and engaged with the second component 60. It is not only time-consuming but also laborious in use of the conventional fastener, and, therefore, it is inconvenient to assemble the first and second components 50, 60 together by using the conventional fastener. Even worse, the spring 30 is easily lost if a careful handling is not given thereto, when the fastener is loosened from the two components 50, 60 to disassemble the two components 50, 60 for a required repair or maintenance of an apparatus using the fastener.

What is needed, therefore, is a fastener having a bolt and a spring assembled together as a single unit so that the fastener can always be ready for use.

### SUMMARY

A fastener for connecting two components together comprises a bolt having a head and a shaft extending integrally and downwardly from the head, an elastic member coiled around the shaft and a shell receiving the elastic member and the bolt therein and keeping the elastic member always coiled around the shaft. The shell encloses the bolt and the elastic member therein as a single unit. The head abuts a top wall of the shell which has a through hole to expose a cross-shaped groove of the head. A lower portion of the shaft extends through a bottom wall of the shell. The elastic member is located between the bottom wall of the shell and the head of the bolt.

Other advantages and novel features of the present invention will become more apparent from the following detailed description of an embodiment/embodiments when taken in conjunction with the accompanying drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a sectional view of a fastener in accordance with a preferred embodiment of the present invention.

FIG. 2 is a sectional view showing the fastener of FIG. 1 fastening related components together.

FIG. 3 is a sectional view showing a fastener in accordance with related art fastening related components together.

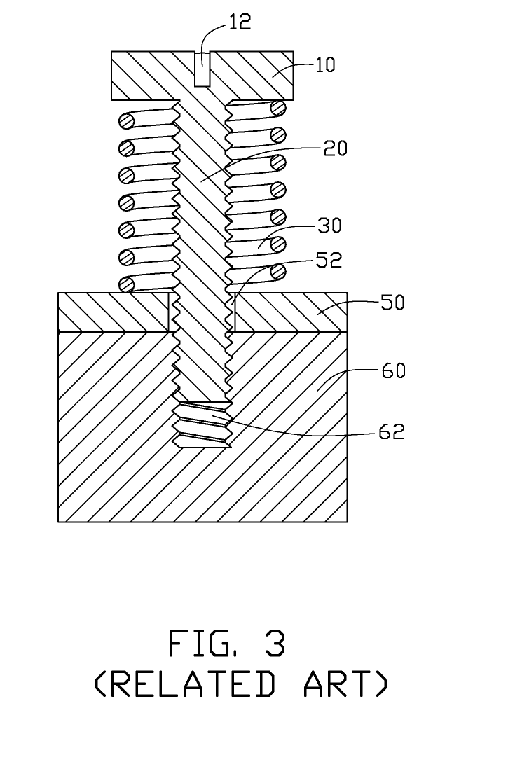

### DETAILED DESCRIPTION

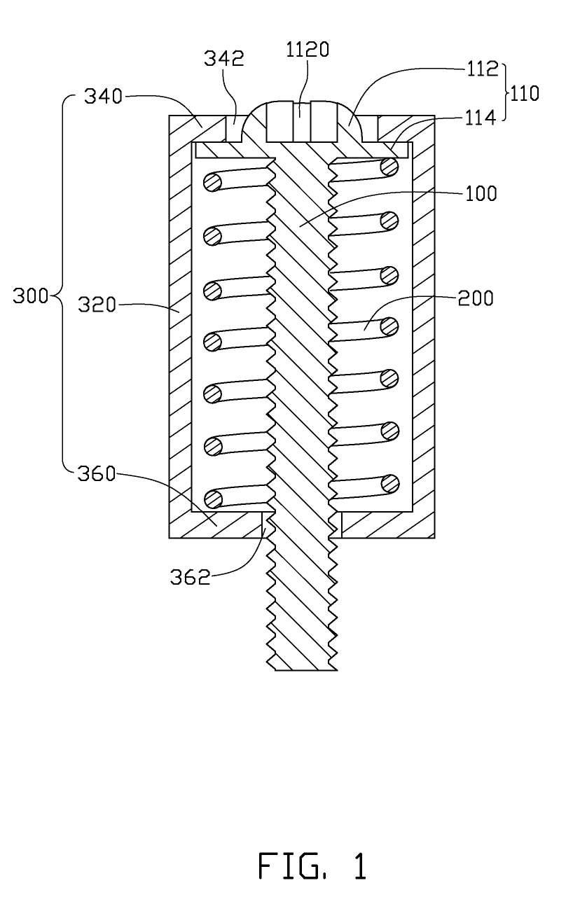

Referring to FIG. 1, a fastener comprises a bolt (not labeled) having a shaft 100 and a head 110, an elastic member 200 coiled around the shaft 100 of the bolt and a shell 300 receiving the bolt and the elastic member 200 therein. In this embodiment, the elastic member 200 is a helical spring. The shaft 100 is machined with outer threads in an exterior thereof. The head 110 extends integrally from a top end of the shaft 100. The head 110 includes an operating portion 112 and a resisting portion 114 extending horizontally and outwardly from a bottom of the operating portion 112. The operating portion 112 defines a cross-shaped groove 1120 in a top end thereof for facilitating operation of a tool such as a screwdriver thereon. The shell 300 includes a column-shaped side wall 320, a top wall 340 and a bottom wall 360 respectively extending perpendicularly and inwardly from a top end and a bottom end of the side wall 320. Through holes 342, 362 are defined in the top wall 340 and the bottom wall 360 respectively. A diameter of the through hole 342 of the top wall 340 is larger than a diameter of the operating portion 112 of the head 110 but smaller than that of the resisting portion 114 of the head 110 to prevent the resisting portion 114 from detaching from the shell 300. The operating portion 112 can extend out of the through hole 342. A diameter of the through hole 362 of the bottom wall 360 is larger than that of the shaft 100 but smaller than that of the elastic member 200 to prevent the elastic member 200 from detaching from the shell 300. A lower portion of the shaft 100 extends through the through hole 362 of the bottom wall 360. The shell 300 encloses the shaft 100 and the elastic member 200 therein to form the fastener as a single unit, wherein, the elastic member 200 is always kept onto the shaft 100. In this embodiment, the elastic member 200 is in an elastically compressed state, an elastic force generated by the elastic member 200 makes the resisting portion 114 always resist against the top wall 340 of the shell 300 and the operating portion 112 extend out of the top wall 340 via the through hole 342. In other embodiments, the elastic member 200 may be in a natural state, so that the resisting portion 114 is not forced to abut against the top wall 340 of the shell 300 and is spaced from the top wall 340.

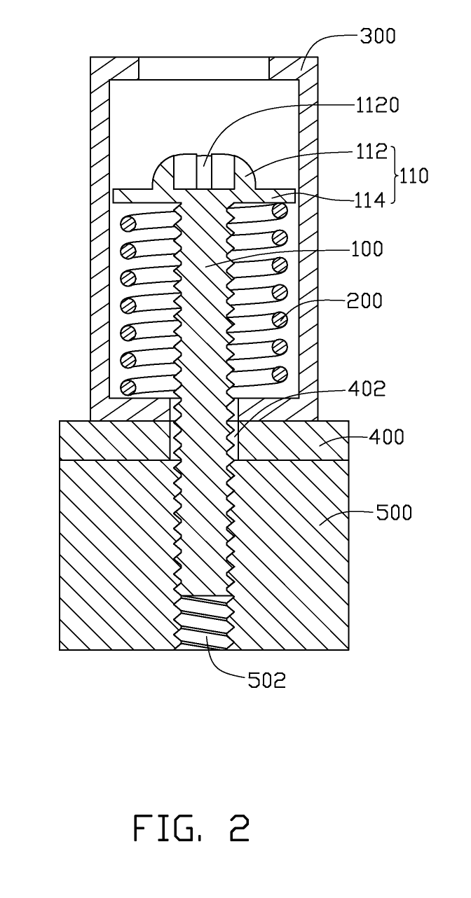

Referring to FIG. 2, the fastener of the present invention can be used for connecting the first component 400 and the second component 500 together. A through hole 402 is defined in the first component 400. In this embodiment, the second component 500 defines a threaded through hole 502 corresponding to the though hole 402 of the first component 400. Alternatively, the threaded through hole 502 can be a threaded blind hole.

In use of the fastener of the present invention, it only needs to extend the shaft 100 through the through hole 402 of the first component 400 and make the shaft 100 align with the threaded through hole 502 of the second component 500. A screwdriver is used which has a tip fitting in the cross-shaped groove 1120 to exerts a downward pressing and turning force on the bolt to drive the shaft 100 to have a threaded engagement with the threaded through hole 502 of the second component 500, thereby fastening the first component 400 and the second component 500 together.

The shell 300 encloses the bolt and the elastic member 200 therein whereby the fastener is formed as a single unit. It is laborsaving and time-saving to keep the elastic member 200 coiling around the shaft 100 by the shell 300 before and during the fastener is engaged with the second component 500. Therefore, the fastener can connect the first component 400 and the second component 500 together conveniently.

In manufacturing of the fastener, first the shell 300 is formed with the top wall 340 aligned with the side wall 320, whereby the bolt with the shaft 100 surrounded by the elastic member 200 is mounted in the inside of the shell 300 through the top thereof, wherein the lower portion of the shaft 100 extends through the through hole 362. Then, the top wall 340 is bent inwardly to define the through hole 342, whereby the elastic member 200, the resisting portion 114 and an upper portion of the shaft 100 are received in the shell 300. Thus, the shell 300, the bolt and the elastic member 200 are assembled together.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1 A fastener used for connecting at least two components together comprising:
a bolt having a head and a shaft extending integrally and downwardly from the head;
an elastic member coiled around the shaft; and
a shell receiving the elastic member and the bolt therein, and keeping the elastic member coiling around the shaft, the shell having a side wall, a top wall extending inwardly from a top of the side wall and defining a first through hole therein and a bottom wall extending inwardly from a bottom of the side wall and defining a second through hole therein, a lower portion of the shaft extending through the second through hole;
wherein the elastic member is blocked between the head of the bolt and the bottom wall of the shell.

2. The fastener as claimed in claim 1, wherein the shaft has a thread formed on an outer circumference thereof.

3. The fastener as claimed in claim 1, wherein a diameter of the second through hole of the bottom wall is larger than that of the shaft but smaller than that of the elastic member to make sure that the elastic member abuts against the bottom wall of the shell.

4. The fastener as claimed in claim 1, wherein the head comprises an operating portion and a resisting portion extending outwardly from a bottom end of the operating portion, and the resisting portion is received in the shell, the elastic member is blocked between the resisting portion and the bottom wall of the shell.

5. The fastener as claimed in claim 4, wherein a diameter of the first through hole of the top wall is larger than a diameter of the operating portion but smaller than that of the resisting portion.

6. The fastener as claimed in claim 4, wherein the elastic member is in an elastically compressed state, the resisting portion abuts against the top wall of the shell and the operating portion extends out of the top wall.

7. The fastener as claimed in claim 4, wherein the elastic member is in a natural state, and the resisting portion is spaced from the top wall.
